(19) United States
(12) Patent Application Publication
(10) Pub. No.: US 2013/0265979 A1
(43) Pub. Date: Oct. 10, 2013

(54) COMMUNICATION TERMINAL DEVICE AND DATA VOLUME REPORTING METHOD

(71) Applicants: Shigeki Yamaguchi, Kanagawa (JP); Takenobu Arima, Kanagawa (JP); Yoshima Shirosaki, Kanagawa (JP)

(72) Inventors: Shigeki Yamaguchi, Kanagawa (JP); Takenobu Arima, Kanagawa (JP); Yoshima Shirosaki, Kanagawa (JP)

(21) Appl. No.: 13/995,084

(22) PCT Filed: Dec. 21, 2011
(86) PCT No.: PCT/JP2011/007164

§ 371 Date: Jun. 17, 2013

(30) Foreign Application Priority Data
Dec. 22, 2010 (JP) 2010-286143

(51) Int. Cl. H04W 72/04

(52) U.S. Cl. CPC H04W 72/0486
USPC 370/329

(57) ABSTRACT

A communication terminal device of the present invention can prevent assignment of unnecessary wireless resources and can efficiently assign the wireless resources in a situation in which there is data that cannot be transmitted immediately. In the device, a MAC control element generation unit (115) generates a BSR MAC control element for reporting to a base station a transmittable data volume. The memory usage management unit (106), if a notification is received that resources have been exhausted from the memory usage management unit (111), or if the stored data volume of a pre-encryption data buffer (102) or a post-encryption data buffer (104) exceeds a threshold, performs a transmittable data volume notification, in which the stored data volumes of the pre-encryption data buffer (102) and the post-encryption data buffer (104) are set to “0,” to the BSR MAC control element generation unit (115).

### TECHNICAL FIELD

The present invention relates to a communication terminal apparatus and a data volume reporting method, and for example, to a communication terminal apparatus and a data volume reporting method for dynamically allocating uplink shared channel resources in a mobile communication system using an uplink shared channel of Long Term Evolution (LTE).

### BACKGROUND ART

In the LTE communication system, a communication terminal apparatus (UE) such as a mobile device is connected to an Evolved Universal Terrestrial Radio Access Network (E-UTRAN) formed by a plurality of base stations (eNodeB) and transmits and receives user data (see, e.g., Non-Patent Literature (hereinafter, abbreviated as “NPL”) 1). The user data transmitted and received between the communication terminal apparatuses and base stations is controlled by Layer 1 and Layer 2 of the LTE communication protocols.

FIG. 1 is a diagram illustrating the protocol configuration of the LTE communication system. As illustrated in FIG. 1, Layer 2 of the LTE communication protocol includes the MAC layer, RLC layer, and PDCP layer. Each communication terminal apparatus transmits transmission data through the PDCP layer, RLC layer, MAC layer, and physical layer (L1), sequentially, while performing predetermined protocol processing on the transmission data in each of the layers. The communication terminal apparatus transmits the transmission data after the protocol processing is performed on the transmission data in the physical layer to the base station. The PDCP layer includes data buffers for temporarily storing the transmission data therein. The RLC layer stores information for managing the transmission data in a data management region of a memory and manages the data. The RLC layer cannot transmit new data until receiving an acknowledgment from the network.

The communication terminal apparatus having the protocol configuration described above needs allocation of radio resources (UL grant) by a base station for transmitting data in uplink (UL-SCH). The base station allocates radio resources to the communication terminal apparatus every transmission time interval (TTI) on the basis of the data volume of transmission data reported from the communication terminal apparatus (buffer status report (hereinafter, referred to as “BSR”)). The communication terminal apparatus uses this BSR to report, to the base station, the data volume in the data buffer of the PDCP layer and the usage of the data management region of memory of the RLC layer used for storing the information for managing the data. Accordingly, the communication terminal apparatus can transmit the data volume corresponding to the radio resources allocated by the base station for the applicable transmission time unit.

As described above, in a mobile communication system using the uplink shard channel of LTE, the network side performs control that dynamically allocates uplink resources on the basis of the report indicating the data volumes in the data buffers and the usage of the data management region used for storing the information for managing the data from the communication terminal apparatus.

### CITATION LIST

### Non-Patent Literature

### NPL 1

3GPP TS36.300 Evolved Universal Terrestrial Radio Access (E-UTRA) and Evolved Universal Terrestrial Radio Access Network (E-UTRAN); Overall description; Stage 2 (Release 8)

### SUMMARY OF INVENTION

### Technical Problem

However, in the related art system, when a large number of communication terminal apparatuses are connected to the base station, or the radio wave environment is not good, the base station cannot allocate radio resources sufficient to cover the transmittable data volume of each of the communication terminal apparatuses. As a result, the communication terminal apparatus cannot transmit transmittable transmission data although the apparatus has transmittable transmission data. For this reason, the communication terminal apparatus cannot release the data buffers in which the transmittable transmission data is stored, or the data management region in which the information for managing the transmittable transmission data is stored. If this situation continues, particularly, a layer distant from the physical layer in the transmission processing system of the communication terminal apparatus (PDCP layer in the case of FIG. 1) cannot pass the transmission data stored in the data buffer to the next layer (RLC layer in the case of FIG. 1). Accordingly, the transmission data stored in the data buffer of a layer distant from the physical layer in the transmission processing system cannot be transmitted immediately. If the communication terminal apparatus uses a BSR and reports the transmittable data volume in the data buffer of each layer in this case, the base station ends up with allocating radio resources for the transmission data that cannot be transmitted immediately. As a result, there arises a problem in that the communication terminal apparatus cannot use all the allocated radio resources and that such allocation turns out to be a waste of radio resources.

It is an object of the present invention to provide a communication terminal apparatus and a data volume reporting method which can prevent allocation of unnecessary radio resources and which enables efficient allocation of radio resources in a situation where there is data that cannot be transmitted immediately.

### Solution to Problem

A communication terminal apparatus according to an aspect of the present invention includes: a first data processing section that performs first protocol processing on transmission data in a first layer; a data storing section that stores transmission data when the first protocol processing is performed; a second data processing section that performs second protocol processing, in a second layer, on the transmission data on which the first protocol processing has been performed; a data management section that stores, in a data management region of a memory, management information on the transmission data on which the second protocol processing is performed, and that performs data management of the transmission data on which the second protocol processing is performed; a reporting section that reports, to a communication counterpart, a transmittable data volume obtained based on a stored data volume of transmission data stored in the data storing section, and a usage of the data management region used for storing the management information; a transmitting section that uses a resource allocated to the transmittable data volume by the communication counterpart and sequentially transmits the transmission data on which the second protocol processing has been performed; a release section that releases, when the communication counterpart succeeds in receiving the transmission data transmitted from the transmission section, the transmission data stored in the data storing section and corresponding to the transmission data that has been successfully received by the communication counterpart, and releases the data management region used for storing the management information on the transmission data that has been successfully received by the communication counterpart; and a report management section that causes, when at least one of the stored data volume and the usage exceeds a predetermined volume, the reporting section to report the transmittable data volume obtained by assuming that there is no stored data volume.

A data volume reporting method according to an aspect of the present invention is a method of reporting a transmittable data volume of a communication terminal apparatus, the method including: first data processing step of performing first protocol processing on transmission data in a first layer; a data storing step of storing transmission data when the first protocol processing is performed; a second data processing step of performing second protocol processing, in a second layer, on the transmission data on which the first protocol processing has been performed; a data management step of storing, in a data management region of a memory, management information on the transmission data on which the second protocol processing is performed, and performing data management of the transmission data on which the second protocol processing is performed; a reporting step of reporting, to a communication counterpart, a transmittable data volume obtained based on a stored data volume of transmission data stored in the data storing step, and a usage of the data management region used for storing the management information; a transmitting step of using a resource allocated to the transmittable data volume by the communication counterpart, and sequentially transmitting the transmission data on which the second protocol processing has been performed; a releasing step of, when the communication counterpart succeeds in receiving the transmission data transmitted in the transmission step, releasing the transmission data stored in the data storing step and corresponding to the transmission data that has been successfully received by the communication counterpart, and releasing the data management region used for storing the management information on the transmission data that has been successfully received by the communication counterpart; and a report management step of causing, when at least one of the stored data volume and the usage exceeds a predetermined volume, the transmittable data volume to be reported in the reporting step, the transmittable data volume being obtained by assuming that there is no stored data volume.

### Advantageous Effects of Invention

According to the present invention, it is possible to prevent allocation of unnecessary radio resources and to efficiently allocate radio resources in a situation where there is data that cannot be transmitted immediately.

### BRIEF DESCRIPTION OF DRAWINGS

FIG. 1 is a diagram illustrating the protocol configuration of the LTE communication system;

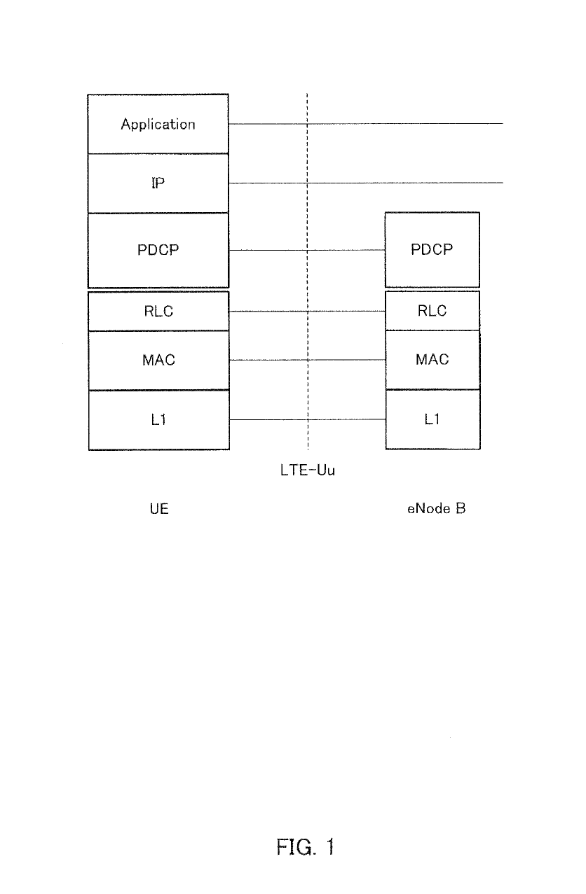

FIG. 2 is a block diagram illustrating a configuration of a communication terminal apparatus according to an embodiment of the present invention; and

FIG. 3 is a diagram illustrating the format of a MAC PDU transmitted by the communication terminal apparatus according to the embodiment of the present invention.

### DESCRIPTION OF EMBODIMENT

Hereinafter, an embodiment of the present invention will be described in detail with reference to the accompanying drawings.

### Embodiment

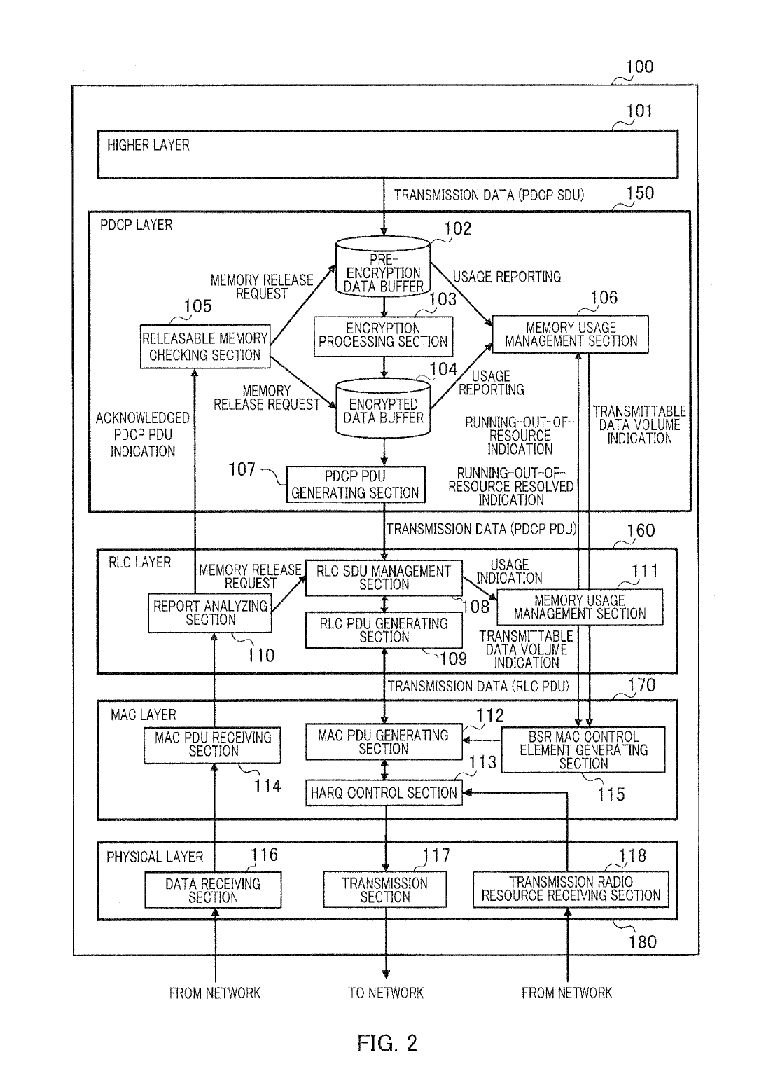

FIG. 2 is a block diagram illustrating a configuration of communication terminal apparatus 100 according to the embodiment of the present invention.

Communication terminal apparatus 100 mainly includes higher layer 101, pre-encryption data buffer 102, encryption processing section 103, encrypted data buffer 104, releasable memory checking section 105, memory usage management section 106, PDCP PDU generating section 107, RLC SDU management section 108, RLC PDU generating section 109, report analyzing section 110, memory usage management section 111, MAC PDU generating section 112, HARQ control section 113, MAC PDU receiving section 114, BSR MAC control element generating section 115, data receiving section 116, transmission section 117, and transmission radio resource receiving section 118.

PDCP layer 150 includes pre-encryption data buffer 102, encryption processing section 103, encrypted data buffer 104, releasable memory checking section 105, memory usage management section 106, and PDCP PDU generating section 107.

RLC layer 160 includes RLC SDU management section 108, RLC PDU generating section 109, report analyzing section 110, and memory usage management section 111.

MAC layer 170 includes MAC PDU generating section 112, HARQ control section 113, MAC PDU receiving section 114, and BSR MAC control element generating section 115.

Physical layer 180 includes data receiving section 116, transmission section 117, and transmission radio resource receiving section 118.

Higher layer 101 generates PDCP SDUs as transmission data and outputs the generated PDCP SDUs to pre-encryption data buffer 102.

Pre-encryption data buffer 102 sequentially stores therein the PDCP SDUs received as input from higher layer 101. In addition, pre-encryption data buffer 102 notifies memory usage management section 106 of the stored data volume of the PDCP SDUs stored therein, using a usage indication. In addition, upon reception of a memory release request from releasable memory checking section 105, pre-encryption data buffer 102 outputs the PDCP SDU for which the release request has been made to encryption processing section 103.

Encryption processing section 103 generates encrypted data by performing encryption processing which is first protocol processing on the PDCP SDU received as input from pre-encryption data buffer 102. In addition, encryption processing section 103 outputs the generated encrypted data to encrypted data buffer 104.

Encrypted data buffer 104 sequentially stores therein encrypted data received as input from encryption processing section 103. In addition, encrypted data buffer 104 notifies memory usage management section 106 of the stored data volume of the encrypted data stored therein, using a usage indication. In addition, upon reception of a memory release request from releasable memory checking section 105, encrypted data buffer 104 outputs the encrypted data for which the request has been made to PDCP PDU generating section 107.

Upon reception of an acknowledged PDCP PDU indication from report analyzing section 110 as input, releasable memory checking section 105 issues a memory release request which is a request to release the indicated acknowledged PDCP PDU to pre-encryption data buffer 102 and encrypted data buffer 104.

Memory usage management section 106 generates a transmittable data volume indication for reporting, to the base station, the stored data volumes notified by pre-encryption data buffer 102 and encrypted data buffer 104 using the usage indications. In this case, upon reception of an indication that the memory has run out of resources, from memory usage management section 111, memory usage management section 106 sets the stored data volume to “0” in the transmittable data volume indication. In addition, when notified that the running out of resources is resolved after notified of the running out of resources, memory usage management section 106 returns the stored data volumes in the transmittable data volume indication to the actual stored data volumes received as input from pre-encryption data buffer 102 and encrypted data buffer 104. Moreover, when the stored data volume in pre-encryption data buffer 102 or encrypted data buffer 104 exceeds a threshold, memory usage management section 106 sets the stored data volume to “0” in the transmittable data volume indication. In addition, memory usage management section 106 returns the stored data volumes in the transmittable data volume indication to the actual stored data volumes notified by the usage indications from pre-encryption data buffer 102 and encrypted data buffer 104, when the stored data volumes of pre-encryption data buffer 102 and encrypted data buffer 104 become equal to or less than the threshold upon release of resources of pre-encryption data buffer 102 and encrypted data buffer 104. In addition, memory usage management section 106 outputs the generated transmittable data volume indication to BSR MAC control element generating section 115. Memory usage management section 106 is notified of the stored data volumes by pre-encryption data buffer 102 and encrypted data buffer 104 every time data processing in PDCP layer 150 is performed.

PDCP PDU generating section 107 generates a PDCP PDU using the encrypted data received as input from encrypted data buffer 104. In addition, PDCP PDU generating section 107 outputs the generated PDCP PDU to RLC SDU management section 108 as transmission data.

RLC SDU management section 108 acquires the RLC SDU (PDCP PDU) from PDCP PDU generating section 107 and manages the data used when data processing on the RLC SDU in RLC layer 160 is performed. Specifically, RLC SDU management section 108 stores management information for managing the acquired RLC SDU (information such as data pointer, data length, or Radio Bearer ID) in the data management region of memory. In addition, RLC SDU management section 108 notifies memory usage management section 111 of the usage of the data management region used for storing the management information (usage indication). In addition, upon reception of a memory release request from report analyzing section 110, RLC SDU management section 108 releases the data management region storing the management information on the RLC SDU for which the release request has been made, and outputs the RLC SDU for which the release request has been made to RLC PDU generating section 109.

Upon reception of a request to acquire a MAC SDU from MAC PDU generating section 112, RLC PDU generating section 109 makes reference to the management information managed by RLC SDU management section 108 (information on RLC SDUs) and performs second protocol processing to generate an RLC PDU by combining or separating RLC SDU data for the required volume. RLC PDU generating section 109 outputs the generated RLC PDU to MAC PDU generating section 112 as transmission data.

Upon reception of an RLC status report from MAC PDU receiving section 114 as input, report analyzing section 110 analyzes the RLC status report received as input and thereby checks the presence or absence of an acknowledgment of the RLC SDU, which indicates reception success transmitted from the base station. In addition, when an acknowledgment of the RLC SDU is present, report analyzing section 110 makes a memory release request which is a request to release the RLC SDU for which the acknowledgement has been acquired to RLC SDU management section 108. In addition, report analyzing section 110 outputs the RLC SDU for which the acknowledgement has been acquired to releasable memory checking section 105 as an acknowledged PDCP PDU indication.

Memory usage management section 111 generates a transmittable data volume indication for reporting, to the base station, the usage of the data management region received as input from RLC SDU management section 108. In addition, memory usage management section 111 outputs the generated transmittable data volume indication to BSR MAC control element generating section 115. Meanwhile, when the usage of the data management region received as input from RLC SDU management section 108 exceeds a threshold, memory usage management section 111 determines that the memory has run out of resources, and thus notifies memory usage management section 106 of the running out of resources (running-out-of-resource indication). When the usage of the data management region received as input from RLC SDU management section 108 becomes equal to or less than the threshold, memory usage management section 111 determines that the running out of memory has been resolved and notifies memory usage management section 106 that the running out of resources has been resolved (running-out-of-resource resolved indication). Memory usage management section 111 acquires the usage of the data management region from RLC SDU management section 108 every time data processing in RLC layer 160 is performed.

MAC PDU generating section 112 generates a MAC PDU by combining a plurality of MAC SDUs (RLC PDUs) received as input from RLC PDU generating section 109. In addition, upon reception of a request to generate new transmission data from HARQ control section 113, MAC PDU generating section 112 makes a request to acquire MAC SDUs to RLC PDU generating section 109. Moreover, according to this request, MAC PDU generating section 112 acquires MAC SDUs (RLC PDUs) from RLC PDU generating section 109 and generates a MAC PDU. When generating a MAC PDU, MAC PDU generating section 112 adds a BSR MAC control element received as input from BSR MAC control element generating section 115 to be described hereinafter, to generate a MAC PDU. In addition, MAC PDU generating section 112 outputs the generated MAC PDU to HARQ control section 113.

HARQ control section 113 performs retransmission control. Specifically, HARQ control section 113 outputs the MAC PDU received as input from MAC PDU generating section 112 as input to transmission section 117 as the initial transmission. In addition, upon reception of a retransmission request from the base station, HARQ control section 113 outputs the MAC PDU to be retransmitted to transmission section 117 for retransmission of the MAC PDU for which the retransmission request has been received. During this processing, HARQ control section 113 repeats retransmission until reception succeeds or the number of retransmissions reaches a predefined maximum number of retransmissions. In addition, HARQ control section 113 determines the transmission data on the basis of the transmission radio resource indication received as input from transmission radio resource receiving section 118 and makes a request to generate new transmission data for the initial transmission to MAC PDU generating section 112 as appropriate.

MAC PDU receiving section 114 detects an RLC status report included in the MAC PDU which is the received data from data receiving section 116, and outputs the detected RLC status report to report analyzing section 110.

BSR MAC control element generating section 115 obtains a transmission data volume transmittable as communication terminal apparatus 100 based on the stored data volumes and the usage of the data management region notified using transmittable data volume indications transmitted respectively from memory usage management section 106 and memory usage management section 111. Specifically, when notified of the actual stored data volumes and the usage of the data management region from memory usage management section 106 and memory usage management section 111, BSR MAC control element generating section 115 obtains a transmittable transmission data volume, using the formation. In addition, when notified by memory usage management section 106, that there is no transmission data, BSR MAC control element generating section 115 obtains a transmittable transmission data volume using only the actual usage of the data managing region received as input from memory usage management section 111 BSR MAC control element generating section 115 generates a BSR. MAC control element reporting the obtained transmittable data volume to the base station. In addition, BSR MAC control element generating section 115 outputs the generated BSR MAC control elements to MAC PDU generating section 112.

Data receiving section 116 extracts a MAC PDU from the data received via the network, by performing physical layer data processing on the data on the physical layer intended for the terminal. Data receiving section 116 outputs the extracted MAC PDU to MAC PDU receiving section 114.

Transmission section 117 performs physical layer data processing on the MAC PDU received as input from HARQ control section 113 and transmits the processed data on the physical channel to the network.

Transmission radio resource receiving section 118 extracts the transmission radio resource indication by performing physical layer data processing on the data which is transmitted on the physical channel intended for communication terminal apparatus 100 and is received from the network. In addition, transmission radio resource receiving section 118 outputs the extracted transmission radio resources to HARQ control section 113.

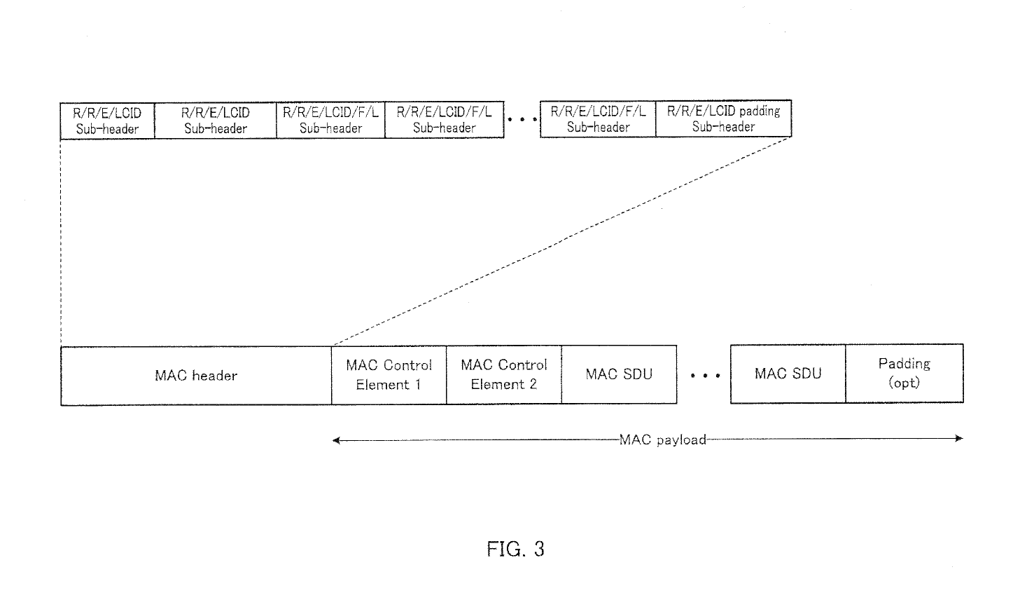

FIG. 3 is a diagram illustrating the formal of a MAC PDU transmitted from communication terminal apparatus 100. As illustrated in FIG. 3, MAC control elements are added to the MAC header. In addition, a plurality of MAC SDUs are added to the MAC control elements. Moreover, the MAC payload includes the MAC control elements and MAC SDUs.

Communication terminal apparatus 100 configured in the manner described above may not be allocated sufficient uplink radio resources due to degradation of the radio link quality between the apparatus and the base station in some cases. Alternatively, communication terminal apparatus 100 may not be able to acquire an acknowledgment of an RLC SDU (PDCP PDU) via an RLC status report due to degradation of the radio link quality between the apparatus and the base station. If the abovementioned situations occur, communication terminal apparatus 100 runs out of pre-encryption data buffer 102 and encrypted data buffer 104 as well as the data management region of RLC SDU management section 108. Accordingly, communication terminal apparatus 100 ends up in a situation where no new data can be transmitted. Even worse, this situation continues until communication terminal apparatus 100 acquires an acknowledgment of an RLC SDU (PDCP PDU) via an RLC status report. Stated differently, this situation continues until pre-encryption data buffer 102 and encrypted data buffer 104 or the data management region of RLC SDU management section 108 of RLC layer 160 is released.

In this embodiment, memory usage management section 106 of PDCP layer 150 sets the transmittable data volume indication to “0” (no transmittable data) after detection of running out of memory in this situation. When the running out of memory is resolved upon release of resources, memory usage management section 106 indicates the data volumes of transmittable transmission data stored in pre-encryption data buffer 102 and encrypted data buffer 104, as usual.

Furthermore, memory usage management section 111 notifies memory usage management section 106 of running out of memory upon detection of running out of memory in the data management region of RLC SDU management section 108. When notified of running out of resources by memory usage management section 111, memory usage management section 106 sets the transmittable data volume indication to “0” (no transmittable data) and notifies BSR MAC control element generating section 115 of the set transmittable data volume indication. Meanwhile, even after notifying memory usage management section 106 of the running out of resources, memory usage management section 111 continues to notify BSR. MAC control element generating section 115 of the actual usage of the data management region notified by RLC SDU management section 108, as usual. As a result, uplink radio resources can be allocated for immediately transmittable data volume in RLC layer 160. The immediately transmittable data volume in RLC layer 160 in this case refers to data which is not affected by running out of memory in the data management region of RLC SDU management section 108 and which is transmittable without waiting for an acknowledgment via an RLC status report. Accordingly, the transmittable data volume of PDCP layer 150 which cannot be transmitted because of running out of memory in the data management region of RLC SDU management section 108 of RCL layer 160 can be limited in BSR MAC control elements. Thus, unnecessary allocation of uplink radio resources can be prevented.

As described above, in this embodiment, when the stored data volume of transmission data stored in one of the data buffers of the PDCP layer exceeds a predetermined volume, a report indicating no transmission data is made for the stored data volumes of transmission data stored in the data buffers of the PDCP layer. Thus, according to the present embodiment, it is possible to prevent allocation of unnecessary radio resources and to efficiently allocate radio resources in a situation where there is data that cannot be transmitted immediately.

Moreover, in this embodiment, when the usage of the data management region used for storing management information on the memory of the RLC layer exceeds a predetermined volume, a report indicating no transmission data is made for the stored data volumes of transmission data stored in the data buffers of the PDCP layer. As a result, according to the present embodiment, it is possible to prevent allocation of unnecessary radio resources and to efficiently allocate radio resources in a situation where there is data that cannot be transmitted immediately.

Furthermore, in this embodiment, even when the usage of the data management region used for storing management information on the memory of the RLC layer exceeds a predetermined volume, the actual usage of the data management region used for storing the management information on the memory of the RLC layer is reported. Thus, according to the present embodiment, radio resources corresponding to the data volume of data that can be transmitted immediately can be allocated.

It should be noted that, in this embodiment, the memory usage management section of the PDCP layer is notified of both of the stored data volumes of the data buffers of the PDCP layer and the usage of the data management region used for storing the management information on the memory of the RLC layer. However, the present invention is not limited to this embodiment, and the usage of the abovementioned data management region may not be notified to the memory usage management section of the PDCP layer.

Moreover, in this embodiment, transmission data before and after encryption processing is stored in the data buffers of the PDCP layer, but the present invention is not limited to this embodiment. Specifically, it is possible to store transmission data before and after any data processing other than the encryption processing.

In this embodiment, the stored data volumes of the two data buffers respectively storing transmission data before encryption and transmission data after encryption are indicated in the PDCP layer, but the present invention is not limited to this embodiment. Specifically, the stored data volume in one or three or more data buffers can be indicated.

The disclosure of the specification, the drawings, and the abstract included in Japanese Patent Application No. 2010-286143, filed on Dec. 22, 2010, is incorporated herein by reference in its entirety.

### INDUSTRIAL APPLICABILITY

The communication terminal apparatus and the data volume reporting method according to the present invention are suitable for dynamically allocating uplink shared channel resources in a mobile communication system using an uplink shared channel of LTE, for example.

### REFERENCE SIGNS LIST

100 Communication terminal apparatus
101 Higher layer
102 Pre-encryption data buffer
103 Encryption processing section
104 Encrypted data buffer
105 Releasable memory checking section
106, 111 Memory usage management section
107 PDCP PDU generating section
108 RLC SDU management section
109 RLC PDU generating section
110 Report analyzing section
112 MAC PDU generating section
113 HARQ control section
114 MAC PDU receiving section
115 BSR MAC control element generating section
116 Data receiving section
117 Transmission section
118 Transmission radio resource receiving section
150 PDCP layer
160 RUC layer
170 MAC layer
180 Physical layer

1. A communication terminal apparatus comprising:
a first data processing section that performs first protocol processing on transmission data in a first layer;
a data storing section that stores transmission data when the first protocol processing is performed;
a second data processing section that performs second protocol processing, in a second layer, on the transmission data on which the first protocol processing has been performed;
a data management section that stores, in a data management region of a memory, management information on the transmission data on which the second protocol processing is performed, and that performs data management of the transmission data on which the second protocol processing is performed;
a reporting section that reports, to a communication counterpart, a transmittable data volume obtained based on a stored data volume of transmission data stored in the data storing section, and a usage of the data management region used for storing the management information;
a transmitting section that uses a resource allocated to the transmittable data volume by the communication counterpart and sequentially transmits the transmission data on which the second protocol processing has been performed;
a release section that releases, when the communication counterpart succeeds in receiving the transmission data transmitted from the transmission section, the transmission data stored in the data storing section and corresponding to the transmission data that has been successfully received by the communication counterpart, and releases the data management region used for storing the management information on the transmission data that has been successfully received by the communication counterpart; and
a report management section that causes, when at least one of the stored data volume and the usage exceeds a predetermined volume, the reporting section to report the transmittable data volume obtained by assuming that there is no stored data volume.

2. The communication terminal apparatus according to claim 1, wherein, when assuming that there is no stored data is volume, the report management section obtains the transmittable data volume based on the usage.

3. The communication terminal apparatus according to claim 1, wherein, when both of the stored data volume and the usage become equal to or less than the predetermined volume after the report management section causes the report section to report the transmittable data volume obtained by assuming that there is no stored data volume, the report management section causes the report section to report the transmittable data volume obtained based on the actual stored data volume and the usage.

4. A data volume reporting method of reporting a transmittable data volume of a communication terminal apparatus, the method comprising:
a first data processing step of performing first protocol processing on transmission data in a first layer;
a data storing step of storing transmission data when the first protocol processing is performed;
a second data processing step of performing second protocol processing, in a second layer, on the transmission data on which the first protocol processing has been performed;
a data management step of storing, in a data management region of a memory, management information on the transmission data on which the second protocol processing is performed, and performing data management of the transmission data on which the second protocol processing is performed;
a reporting step of reporting, to a communication counterpart, a transmittable data volume obtained based on a stored data volume of transmission data stored in the data storing step, and a usage of the data management region used for storing the management information;
a transmitting step of using a resource allocated to the transmittable data volume by the communication counterpart, and sequentially transmitting the transmission data on which the second protocol processing has been performed;
a releasing step of, when the communication counterpart succeeds in receiving the transmission data transmitted in the transmission step, releasing the transmission data stored in the data storing step and corresponding to the transmission data that has been successfully received by the communication counterpart, and releasing the data management region used for storing the management information on the transmission data that has been successfully received by the communication counterpart; and
a report management step of causing, when at least one of the stored data volume and the usage exceeds a predetermined volume, the transmittable data volume to be reported in the reporting step, the transmittable data volume being obtained by assuming that there is no stored data volume.
